(19) United States
(12) Patent Application Publication
(10) Pub. No.: US 2009/0143245 A1
(43) Pub. Date: Jun. 4, 2009

(54) MICROARRAYS FOR GENOTYPING AND METHODS OF USE

(76) Inventors: Huafang Gao, Beijing (CN); Ze Li, Beijing (CN); Dong Wang, Beijing (CN); Yanhua Liu, Beijing (CN); Xiang Liu, Beijing (CN); Yangzhou Jiang, Beijing (CN); Chuanzan Zhao, Beijing (CN); Li Li, Beijing (CN); Gengxin Lan, Beijing (CN); Tao Guo, Beijing (CN); Bin Cai, Beijing (CN); Wanli Xing, Beijing (CN); Yuxiang Zhou, Beijing (CN); Jing Cheng, Beijing (CN)

Correspondence Address: MORRISON & FOERSTER LLP, 12531 HIGH BLUFF DRIVE, SUITE 100, SAN DIEGO, CA, 92130-2040, US

(21) Appl. No.: 12/093,504

(22) PCT Filed: Feb. 20, 2006
(86) PCT No.: PCT/CN2006/000237

§ 371 Date: Oct. 10, 2008

(30) Foreign Application Priority Data
Nov. 15, 2005 (CN) 200510123228.0

(51) Int. Cl. C40B 30/10; C40B 40/08; C40B 50/06

(52) U.S. Cl. 506/12; 506/17; 506/26

(57) ABSTRACT

The present invention provides a microarray for detecting a genotype at a polymorphic site in a plurality of nucleic acid samples, comprising a first set of nucleic acid fragments derived from the samples and a second set of nucleic acid fragments derived from a plurality of references immobilized thereon. The invention also provides a microarray comprising a set of nucleic acid fragments immobilized on the surface of the microarray, wherein the nucleic acid fragments are derived from the samples by amplifying a region in the sample containing the polymorphism through asymmetric PCR amplification. Methods of using and making the microarrays are also provided.

### TECHNICAL FIELD

This invention generally relates to microarrays and their applications.

### BACKGROUND OF THE INVENTION

Biochip (microarray) technologies have rapidly developed in the past few years. See, e.g., Fodor et al., Science 251:767-773 (1991); Marshall et al., Nat. Biotechnol. 16:27-31 (1998). One of the advantages of microarrays is high throughput. For example, microarrays, such as commonly used cDNA microarrays, can be used to detect different aspects of a sample. Specifically, a plurality of probes immobilized on the surface of the microarray are used to detect target molecules in a sample. This is called reverse hybridization (or negative hybridization). On the other hand, microarrays can also be used to detect the same aspect in different samples. Specifically, target molecules to be detected are immobilized on the surface of the microarray, and are detected by one or more probes in the solution. This is called obverse hybridization (or positive hybridization).

The proper choice of positive and negative controls is critical for a successful obverse hybridization. Typically, multiple probes are needed in an obverse hybridization experiment in order to obtain the desired information. This makes it very difficult to design the microarrays and to properly analyze the experimental results. Furthermore, because target molecules for obverse hybridization are usually amplification products derived from nucleic acid samples using traditional PCR methods, the sensitivity of the obverse hybridization is sometimes limited by the limited efficacy of traditional PCR methods.

### BRIEF SUMMARY OF THE INVENTION

Provided herein are microarrays for detecting a genotype at a polymorphic site in a plurality of samples. The microarrays comprise a first set of nucleic acid fragments derived from the samples and a second set of nucleic acid fragments derived from a plurality of references, wherein the first set of nucleic acid fragments and the second set of fragments are produced by amplifying a region in the samples and references containing the polymorphic site under the same conditions, wherein both sets of nucleic acid fragments are immobilized on the surface of said microarray, and wherein each reference comprises a known genotype at the site of the polymorphism.

Also provided are methods of using the microarrays for the detection of the genotype at a polymorphic site in a plurality of samples. The method comprises: a) contacting a probe with the microarray, wherein the probe detects a known genotype at the polymorphic site in at least one of the references; b) comparing the detection signal of each sample with the detection signal of at least one of the references; and c) determining the presence or absence of the genotype at the site of the polymorphism in each sample based on the comparison.

In some embodiments, the microarray is used for detecting a genotype at a polymorphic site in an HLA gene, and the references comprise one or more HLA standard samples. In some embodiments, each of the references comprises a different HLA standard sample, such as a different HLA standard sample selected from the group consisting of HLA standard samples shown in FIG. 4. In some embodiments, the references consist essentially of HLA standard samples shown in FIG. 4.

In another aspect, there is provided a microarray comprising a set of nucleic acid fragments immobilized on the surface of the microarray, wherein the nucleic acid fragments are derived from the samples by amplifying a region in the sample (such as a region containing the polymorphic site) through asymmetric PCR amplification. The present invention also provides methods of making the microarray described herein. In some embodiments, the method comprises (a) amplifying a region in each sample (such as a region containing a polymorphic site) through asymmetric PCR amplification to produce a set of nucleic acid fragments; and (b) immobilizing the nucleic acid fragments on the surface of the microarrays.

Also provided are methods of detecting a genotype at a polymorphic site in a plurality of samples, comprising (a) amplifying a region in each sample containing a polymorphic site through asymmetric PCR amplification to produce a set of nucleic acid fragments; (b) immobilizing the nucleic acid fragments on the surface of the microarrays; (c) contacting a probe with the microarray; and (d) determining the genotypes of each sample based on signals produced by the probe.

In some embodiments, the molar ratio of the primers (upstream and downstream primers, in particular) for the asymmetric PCR amplification is about 12.5:1 to about 100:1. In some embodiments, the molar ratio is about 12.5:1. In some embodiments, the number of PCR cycles of the asymmetric PCR amplification is about 30-40. The microarray may be used, for example, for detecting a genotype at a polymorphic site (such as a polymorphic site at the HLA gene locus) in a plurality of nucleic acid samples.

### DESCRIPTION OF FIGURES

FIG. 1 shows the spotting pattern of unknown HLA samples and HLA standard samples on one exemplary microarray of the present invention. PC represents positive control; BC represents blank control; S1-S52 represent HLA standard samples.

FIG. 2 shows the predicted hybridization pattern of the HLA standard samples using the microarray shown in FIG. 1.

FIG. 3 shows the real hybridization results using the microarray shown in FIG. 1.

FIG. 4 shows a list of HLA standard samples.

FIG. 5 shows a schematic diagram of an exemplary asymmetric PCR amplification reaction.

FIGS. 6A-6C show agarose gel electrophoresis analysis of PCR amplification products produced by three different PCR reactions: symmetric PCR amplification, asymmetric PCR amplification, and nested PCR amplification. Lane M in FIGS. 6A, 6B, and 6C is DL2000 DNA marker (Takara, Bio Inc Dalian, China). Lane N in FIGS. 6A and 6C is blank control for the amplification reaction. The Sym lane in FIG. 6A is a product of symmetric PCR amplification. Lanes 4-1, 4-2, 4-3, 4-4 in FIG. 6B are four repeats of symmetric PCR amplification. Lane 4-N is a blank control. Lanes Tao-1 and Tao-2 in FIG. 2C are two repeats of nested PCR amplification.

FIG. 7 provides a diagram showing the hybridization signals of three different PCR reactions. The three bars for each PCR reaction represents three different concentrations of the PCR products immobilized on the microarray: 100 ng/ul; 150 ng/ul; and 200 ng/ul, respectively.

FIG. 8 provides sequences of several polymorphic alleles at positions 96-114 of the HLA-B locus. These sequences can also be used as probes. Column III provides the number of alleles that are known to match the sequences listed on column II. Column IV lists the specific gene groups that contain the sequences. For example, 07/37:38 means there are 38 alleles in HLA-B*07 groups and that 37 out of all the 38 alleles matched to the probe and should give a positive signal.

### DETAILED DESCRIPTION OF THE INVENTION

Provided herein are microarrays for detecting a genotype at a polymorphic site in a plurality of samples. The microarrays comprise a first set of nucleic acid fragments derived from a plurality of samples and a second set of nucleic acid fragments derived from a plurality of references. Each reference comprises a known genotype (and typically a different genotype) at the polymorphic site, and thus serves as positive controls for detection of the same genotype at the polymorphic site in the samples. The first set of nucleic acid fragments and the second set of nucleic acid fragments are produced by amplifying a region in the samples and references containing the site of the polymorphism under the same conditions. Accordingly, the second set of the nucleic acid fragments derived from the references mimic the same hybridization environment as the first set of nucleic acid fragments derived from the samples, and serve as accurate positive controls for the detection. Because each reference comprises a different known genotype at the site of the polymorphism, nucleic acid fragments derived from them can serve as positive controls for different probes. The microarrays described herein are therefore particularly useful when multiple different probes are used.

In another aspect, the invention provides a microarray comprising a set of nucleic acid fragments immobilized on the surface of the microarray, wherein the nucleic acid fragments are derived from the samples by amplifying a region in the sample (such as a region containing the polymorphic site) through asymmetric PCR amplification. Asymmetric PCR amplification produce higher concentrations of single stranded nucleic acid products, which in turn provide stronger hybridization signals and higher hybridization efficiency for the microarray.

Samples and Nucleic Acid Fragments Derived from the Samples

The present invention provides microarrays for detecting a genotype at a polymorphic site in a plurality of samples. The term “sample” refers to a material suspected of containing a nucleic acid of interest. Such samples include biological fluids such as blood, serum, plasma, sputum, lymphatic fluid, semen, vaginal mucus, feces, urine, spinal fluid, and the like; biological tissue such as hair and skin; and so forth. Other samples include cell cultures and the like, plants, food, and forensic samples. When necessary, the sample may be pretreated with reagents to liquefy the sample and/or release the nucleic acids from binding substances. Such pretreatments are well known in the art.

In some embodiments, the samples are obtained directly from a subject without further processing. “Subject” used herein include, but is not limited to, bacteria, viruses, plants, mammals (such as human, bovine, primate, equine, canine, feline, porcine, and ovine animals). The nucleic acid can be only a minor fraction of a complex mixture such as a biological sample. In some embodiments, the nucleic acid can be isolated or purified from a biological sample by procedures well known in the art. An “isolated” or “purified” molecule is one that is substantially free of the materials with which it is associated in nature. By substantially free is meant at least 50%, preferably at least 70%, more preferably at least 80%, and even more preferably at least 90% free of the materials with which it is associated in nature.

As used herein, the terms “nucleic acid” and “polynucleotide” are interchangeable and refer to any nucleic acid, whether composed of deoxyribonucleosides or ribonucleosides, and whether composed of phosphodiester linkages or modified linkages such as phosphotriester, phosphoramidate, siloxane, carbonate, carboxymethylester, acetamidate, carbamate, thioether, bridged phosphoramidate, bridged methylene phosphonate, phosphorothioate, methylphosphonate, phosphorodithioate, bridged phosphorothioate or sulfone linkages, and combinations of such linkages.

Furthermore, a nucleic acid or polynucleotide described herein may comprise at least one modified sugar moiety selected from the group including but not limited to arabinose, 2-fluoroarabinose, xylulose, and hexose. The polynucleotide may be DNA, RNA, cDNA, DNA-RNA, peptide nucleic acid (PNA), a hybrid or any mixture of the same, and may exist in a double-stranded, single-stranded or partially double-stranded form.

The microarrays described herein allows detection of a genotype at a polymorphic site in a plurality of samples. For example, the microarray can be used to determine the genotypes in at least any of 2, 3, 5, 10, 20, 30, 40, 50, 60, 70, 80, 90, 100, 200, 300, 400, 500, or 1000 samples. “Polymorphic site” or “site of polymorphism” means a given nucleotide location in a genetic locus which is variable within a population. The polymorphism can be any polymorphism in a nucleic acid sequence, e.g., a single or multiple base substitution or polymorphism, a deletion or an insertion. “Genotyping” or “detecting a genotype” refers to identification or detection of a specific variation (such as the sequence) at the site of the polymorphism.

The microarray comprises a first set of nucleic acid fragments derived from the samples. The nucleic acid fragments can be of any length, as long as they encompass the site of polymorphism to be genotyped. For example, the nucleic acid fragments can be at least about any of 10, 20, 30, 40, 50, 60, 70, 80, 90, 100, 200, 300, 400, 500, 600, 700, 800, 900, 1000 base pairs long. In some embodiments, the nucleic acid fragments comprise more than one site (such as any of 2, 3, 4, 5, 6 sites) of polymorphism.

In some embodiments, the microarray comprises at least any of 10, 20, 30, 40, 50, 100, 200, 300, 400, 500, 600, 700, 800, 900, or 1000 nucleic acid fragments derived from the samples. The nucleic acid fragments are mostly different from each other (i.e., they are derived from different samples or represent different regions of the same sample), but in some embodiments, some of the nucleic acid fragments may be identical to each other. For example, the same amplification product from the same sample may be immobilized on more than one spot (such as at least any of 2, 3, 4, 5, spots) on the microarray to increase accuracy of the detection. In some embodiments, the nucleic acid fragments are double stranded nucleic acids. In some embodiments, the nucleic acid fragments are single stranded nucleic acids.

In some embodiments, the nucleic acid fragments are produced by amplifying a region in the sample containing the polymorphic site. “Amplification” refers to any form of preferential increase in the amount of one region of polynucleotide in a sample. The term “amplification,” as applied to nucleic acids refers to any method that results in the formation of one or more copies of a nucleic acid, where preferably the amplification is exponential. One such method for enzymatic amplification of specific sequences of DNA is known as the polymerase chain reaction (PCR), as described by Saiki et al., 1986, Science 230:1350-1354.

Primers used in PCR can vary in length from about 10 to 50 or more nucleotides, and are typically selected to be at least about 15 nucleotides to ensure sufficient specificity. Normally, the hybridizable sequence of the primer has at least 90%, preferably 95%, most preferably 100%, complementarity to a defined sequence or primer binding site. The number of nucleotides in the hybridizable sequence of an oligonucleotide primer should be such that stringency conditions used to hybridize the oligonucleotide primer will prevent excessive random non-specific hybridization. Usually, the number of nucleotides in the hybridizable sequence of the oligonucleotide primer will be at least ten nucleotides, preferably at least 15 nucleotides and, preferably 20 to 50, nucleotides. In addition, the primer may have a sequence at its 5′-end that does not hybridize to the sample or reference polynucleotides that can have 1 to 60 nucleotides, 5 to 30 nucleotides or, preferably, 8 to 30 nucleotides. Because these sequences are shared among all the nucleic acid fragments produced by the PCR reaction, they may serve as a target sites for a probe for normalizing the hybridization signals.

In some embodiments, the nucleic acid fragments are produced by traditional PCR amplification methods (i.e., symmetric PCR amplification methods). In some embodiments, the nucleic acid fragments are produced by nested PCR amplification methods. Nucleic acids fragments produced by traditional or nested PCR amplification methods are typically double stranded. In some embodiments, these nucleic acid fragments are denatured (such as heat-denatured) to produce single stranded nucleic acids before being immobilized on the surface of the microarray.

In some embodiments, the nucleic acid fragments are produced by asymmetric PCR amplification. Asymmetric PCR is a method used for rapidly amplifying a single strand nucleic acid. Unlike normal PCR reactions where the concentrations of the pair of primers used are equal, in asymmetric PCR, the concentration of one of the primers is raised to several times, or several dozen times that of the other primer. By so doing, the lower concentration primer is consumed first, and the remaining PCR proceeds only from the residual higher concentration primer, producing a large quantity of the DNA strand corresponding with the higher concentration primer. Similarly, in thermal asymmetric PCR, which represents one specific type of asymmetric PCR, a pair of primers is used which display a difference in Tm of at least 10 ° C., and first PCR is conducted under conditions in which the primer with the lower Tm value will also undergo annealing, and subsequently PCR is conducted under conditions in which only the primer with the higher Tm value will undergo annealing. Asymmetric PCR results in only one of the complementary strands of each partial being accumulated in significant amounts. These single stranded nucleic acids produced by asymmetric PCR amplification have high hybridization efficiency, can produce strong hybridization signals with probes, and are thus particularly useful for genotype determination at site of polymorphisms.

In some embodiments, the microarray is useful for detecting a genotype at a polymorphic site in an HLA (human leukocyte antigen) gene. The HLA gene complex located on the short arm of human chromosome six is part of the major histocompatibility complex (MHC). These genes encode cell-surface proteins which regulate the cell-cell interactions of the immune response. The various HLA Class I loci encode the HLA antigens, 44,000 dalton polypeptides which associate with B-2 microglobulin at the cell surface. The Class I molecules are involved in the recognition of target cells by cytotoxic T lymphocytes. HLA Class II loci encode cell surface heterodimers, composed of proteins of 29,000 and 34,000 daltons, respectively. These Class II molecules are also involved in the recognition of target cells by helper T lymphocytes.

The HLA-A, HLA-B, and HLA-C loci of the HLA Class I region as well as the HLA-DRB, HLA-DQB, HLA-DQA, HLA-DPB and HLA-DPA loci of the HLA Class II region exhibit an extremely high degree of polymorphism. The WHO nomenclature committee for factors of the HLA system [Marsh and Bodmer, Immunoqenetics, 31:131 (1990)] designated 25 alleles of HLA-A (HLA-A-0 101, A-0201, etc.), 32 alleles of HLA-B, and 11 alleles of HLA-C, 43 HLA-DRB alleles, 13 HLA-DQB alleles, 8 HLA-DQA alleles, 4 HLA-DPA alleles and 19 HLA-DPB alleles. This high degree of polymorphism is thought to relate to the function of the HLA molecules, and HLA genotyping plays an important role in the human and tissue organ transplant, disease diagnosis and treatment, forensic determinations, immunology, and genetic research.

In some embodiments, the microarray is used to determine a genotype at a polymorphic site in a class I or class II HLA gene. In some embodiments, the HLA genes are selected from the group consisting of HLA-A, HLA-B, HLA-C, HLA-DRB, HLA-DQB, HLA-DQA, HLA-DPB and HLA-DPA. Nucleic acid fragments comprising any of these HLA genes can be produced by methods known in the art. For example, they can be produced by amplifying any one of these genes using locus-specific primers known in the art.

Mircoarrays Comprising Nucleic Acid Fragments Derived from a Plurality of References

In order to determine the genotype of target nucleic acids in the samples, the target nucleic acid can be compared to a reference nucleic acid. “Reference” refers to a known sample containing a known genotype at the site of polymorphism. The references can be either naturally occurring or artificially modified from naturally occurring samples. For example, the reference may be a sample that has been previously genotyped using methods described herein or other methods known in the art.

In one aspect of the present invention, the microarrays comprise a second set of nucleic acid fragments derived from a plurality of references. Typically, the second set of nucleic acid fragments are related to some or all of the first set of nucleic acid sequences derived from the samples. The nucleic acid fragments can be related if the they are either identical, or would be identical if not for certain difference between the two sequences, for example, at the site of the polymorphism.

In some embodiments, the second set of nucleic acid fragments are produced from the references using the same amplification method and condition as those of the samples. For example, the same set of primers may be used to in the amplification reactions for both the samples and the references. The amplification reactions may use the same thermal cycle. Because the second set of nucleic acid fragments are produced in the same way as the first set of nucleic acid fragments, variables introduced by the overall environment of different samples can be minimized. The references (specifically, the nucleic acid fragments derived from the references) thus serve as better positive controls for the samples. Furthermore, for each probe used for the determination of a particular genotype, references (specifically, nucleic fragments derived from the references) containing known genotypes other than that particular genotype may serve as good negative controls for the detection. The references thus collectively serve as a good indicator of whether or not the microarray system functions in a desired manner.

The nucleic acid fragments derived from the references can be of any length, as long as they encompass the site of polymorphism where the known genotype is located. For example, the nucleic acid fragments can be at least about any of 10, 20, 30, 40, 50, 60, 70, 80, 90, 100, 200, 300, 400, 500, 600, 700, 800, 900, 1000 base pairs long. In most cases, the nucleic acid fragments only comprises one site of polymorphism. In some embodiments, however, the nucleic acid fragments may comprise more than one site (such as any of 2, 3, 4, 5, 6 sites) of polymorphism.

In some embodiments, the microarray comprises at least any of 10, 20, 30, 40, 50, 100, 200, 300, 400, 500, 600, 700, 800, 900, or 1000 nucleic acid fragments derived from references. The nucleic acid fragments are mostly different from each other (i.e., they are derived from different references or represent different regions of the same reference), but in some embodiments, some of the nucleic acid fragments may be identical to each other. For example, the same amplification product from the same reference may be immobilized on more than one spot (such as at least any of 2, 3, 4, 5, spots) on the microarray to increase accuracy of the detection. In some embodiments, the nucleic acid fragments are double stranded nucleic acids. In some embodiments, the nucleic acid fragments are single stranded nucleic acids.

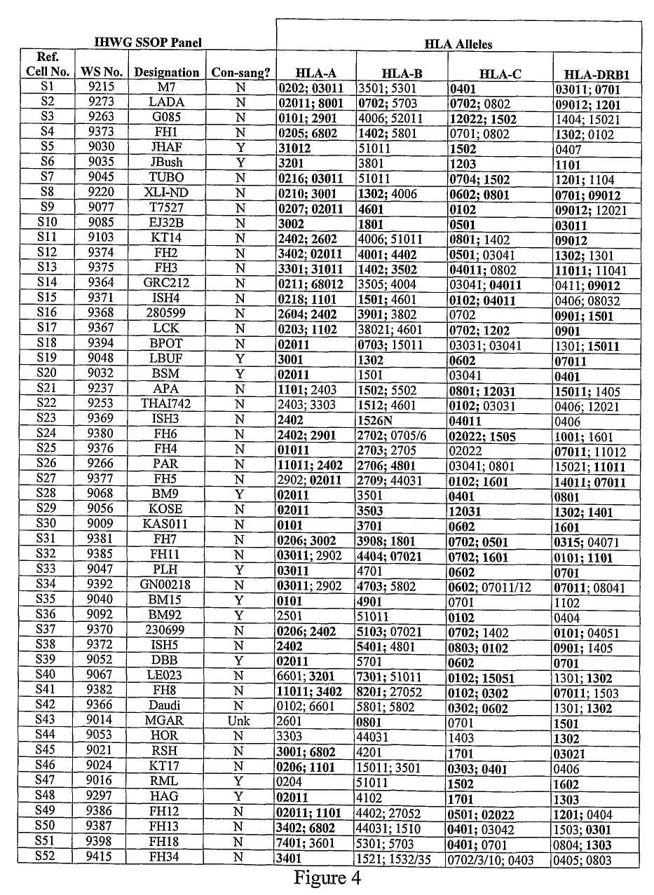

In some embodiments, the microarray comprises nucleic acid fragments derived from at least any of: 10, 15, 20, 25, 30, 35, 40, 45, 50, 55, 60, 65, 70, 75, 80, 85, 90, 95, or 100 references. In some embodiments, the references are different HLA standard samples. Various HLA standard samples are known in the art. For example, International HLA database Information (available at http://www.ebi.ac.uk/imgt/hla) provides information about various HLA standard samples. In some embodiments, the references are selected from the group consisting of HLA standard samples shown in FIG. 4. In some embodiments, the references on the microarray consist essentially of standard samples shown in FIG. 4.

Also provided are methods of using the microarrays described herein for detecting the genotype at a polymorphic site in a plurality of samples. The methods typically involve (a) contacting a probe with a microarray comprising a first set of nucleic acid derived from the samples and a second set of nucleic acid fragments derived from a plurality of references as described above, wherein the probe detects a known genotype at the site of the polymorphism in at least one of the references; (b) comparing the detection signal of each sample with the detection signal of at least one of the references; and (c) determining the presence of absence of the genotype at the polymorphic site in each sample based on the comparison. For example, if the probe that detects a nucleic acid fragment derived from a reference comprising a known genotype also detects a nucleic acid fragment derived from a sample, it can be determined that the sample has the same genotype as the reference. In some embodiments, the detection signal of nucleic acid fragments derived from each sample is compared with detection signals of more than one nucleic acid fragments derived from references, and the collective results of the comparison indicate the genotype of the sample.

The probes described herein can be any molecule that detects the presence of a genotype at a site of polymorphism, and can include, for example, synthetic oligonucleotide, cDNA, RNA, PNA, or protein/antibodies that recognizes the site of polymorphism. In some embodiments, the probe is a nucleic acid containing a sequence that is complementary to the polymorphic site with a particular genotype. The probe can be of any length that is suitable for detection. For example, when the probe is a nucleic acid, it can be about 10 to about 100 nucleotides, such as about 10 to about 50, such as about 15 to about 20 nucleotides.

Typically, the probes are labeled, either directly or indirectly, by detectable groups that produces a detectable signal. The signal may also be amplified prior to detection by methods known in the art. The presence of a detectable signal indicates the presence of the corresponding target in the sample. The probes may also be labeled by radiolabeling, chemolabeling, enzyme labeling, luminescent labeling, colloidal gold labeling with silver staining maginification, magnetic beads labeling, or fluorescence resonance energy transfer labeling. The hybridization signals may be further amplified prior to detection. Methods of detection are known in the art. For example, the microarrays can be scanned by a microarray scanner, such as LuxScan 10K microarray scanner from CapitalBio.

In some embodiments, a plurality of probes (such as any of 2, 3, 4, 5, 6, 7, 8, 9, or 10 probes) are used for detection of different genotypes. The probes may be brought into contact with the microarray simultaneously (such as within several minutes). For example, the different probes can be labeled (directly or indirectly) with different detection groups and can thus be detected simultaneously. Alternatively, the probes may be brought into contact with the microarray at different times (such as with a time separation of several minutes, several days, several weeks, or several month). For example, the microarray may be reused several times by first detecting targets using a particular probe or a particular set of probes, washed, stripped, dried and brought into contact with another probe or another set of probes.

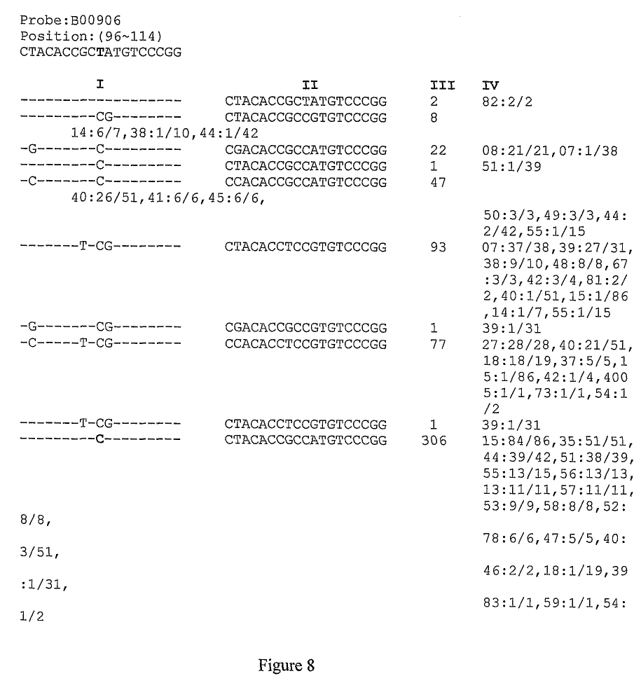

The methods described herein may be used, for example, for determining single nucleotide polymorphisms (“SNP”). For example, FIG. 8 provides sequences at a polymorphic site on the HLA-B locus, in which a single nucleotide sequence difference can be detected by methods described herein. These sequences can also be used as probes for detecting other sites of polymorphisms. Microarray comprising nucleic acid fragments produced by asymmetric PCR

Also provided herein are microarrays comprising a set of nucleic acid fragments immobilized on the surface of the microarray, wherein the nucleic acid fragments are derived from the samples by amplifying a region (such as a region containing the polymorphic site) in the sample through asymmetric PCR amplification. The microarray may be used, for example, for detecting a genotype at a site of polymorphism (such as a genotype at a site of polymorphism at the HLA gene locus) in a plurality of nucleic acid samples.

The present invention also provides methods of making the microarray described herein. In some embodiments, the method comprises (a) amplifying a region in each sample (such as a region containing a polymorphic site) through asymmetric PCR amplification to produce a set of nucleic acid fragments; and (b) immobilizing the nucleic acid fragments on the surface of the microarrays.

Also provided are methods of detecting a genotype at a polymorphic site in a plurality of samples, comprising (a) amplifying a region in each sample containing a polymorphic site through asymmetric PCR amplification to produce a set of nucleic acid fragments; (b) immobilizing the nucleic acid fragments on the surface of the microarrays; (c) contacting a probe with the microarray; and (d) determining the genotypes of each sample based on signals produced by the probe.

In some embodiments, the molar ratio of the primers (such as upstream and downstream primers) for the asymmetric PCR amplification is about 12.5:1 to about 100:1. In some embodiments, the molar ratio is about 100:1. In some embodiments, the number of PCR cycles of the asymmetric PCR amplification is at least about 30, such as at least about 35, such as at least about 40. In some embodiments, the number of PCR cycles of the asymmetric PCR amplification is about 30-40. In some embodiments, the molar ratio of the upstream and downstream primers for the asymmetric PCR amplification is about 12.5:1 to about 100:1 and the number of PCR cycles is about 30-40.

In some embodiments, the microarray is useful for detecting a genotype at a polymorphic site in an HLA (human leukocyte antigen) gene. In some embodiments, the microarray is used to determine a genotype at a polymorphic site in a class I or class II HLA gene. In some embodiments, the HLA genes are selected from the group consisting of HLA-A, HLA-B, HLA-C, HLA-DRB, HLA-DQB, HLA-DQA, HLA-DPB and HLA-DPA. In some embodiments, the HLA gene is HLA-DRB.

In some embodiments, the nucleic acid fragments immobilized on the microarray are amplification products of the HLA-DRB gene of the HLA gene complex. In some embodiments, the nucleic acid fragments are amplified by using the following primers:

HLA-DkB1primers (5′-3′) (Asymmetric PCR):
Upstream primer PMH_0303047a
GATCCTTCGTGTCCCCACAGCAC
Downstream primer PMH_0303048d
CGCTGCACTGTGAAGCTCTCAC

### Other Features of the Micorarrays

The microarrays described herein may further comprise various additional controls. For example, when the samples are nucleic acid samples, the microarray may comprise positive controls for hybridization reactions. The positive control for hybridization reactions can be any nucleic acid that contains a target site for a probe. A positive signal from the positive control site would indicate that the hybridization is successful. In this regard, a positive control for hybridization reaction is different from a nucleic acid fragment derived from a reference, in that a nucleic acid fragment derived from a reference is typically related to nucleic acid fragments derived from samples, while the positive control for hybridization reaction can be any kind of unrelated molecule, as long as it can be recognized by a probe. In some embodiments, the microarray may comprise blank controls, such as a blank buffer. In some embodiments, the microarray may further comprise a quality control for the immobilization step. For example, a labeled oligonucleotide probe can be immobilized on the surface of the microarray, and signals derived from the probe can serve as an indicator of the immobilization quality.

The microarrays described herein can be any kind of microarrays known in the art. Exemplary formats include membrane or filter arrays (e.g., nitrocellulose, nylon), pin arrays, and bead arrays (e.g., in a liquid “slurry”). Essentially any solid support capable of withstanding the reagents and conditions necessary for performing the particular expression assay can be utilized. For example, functionalized glass, silicon, silicon dioxide, modified silicon, glass, quartz glass, plastic, ceramic, rubber, metal, any of a variety of polymers, such as (poly)tetrafluoroethylene, (poly)vinylidenedifluoride, polystyrene, polycarbonate, or combinations thereof can all serve as the substrate for a solid phase array.

Various methods of immobilizing samples (and references) on a surface of the microarrays are known in the art. Chemical reaction radicals, such as —CHO, —NH2, SH, —S—S—, epoxy radical and toluenesulfon radical, or biomolecules, such as biotin, streptavidin, affinity, his-tag, strept-tag, histidine, and protein A can be linked on the surface of the substrate for immobilizing nucleic acid fragments described herein. In an exemplary method, nucleic acid samples can be mixed with equal volume of dimethylsulfoxide and placed in multi-well microtiter places. The plates can be placed on a Gen III micro Array Spotter and spotted on silane-coated microscope glass slides. After spotting, the slides can be air dried and subjected to ultraviolate irradiation. The slides can be used immediately or desiccated until ready for use.

### EXAMPLE

### Example 1

This example demonstrates use of an exemplary microarray of the present invention to detect genotypes in multiple HLA samples.

85 unknown DNA samples were obtained from blood samples by phenol/choloroform extraction method. 52 HLA standard samples were obtained from International Histocompatibility Working Group (IHWG). These HLA standard samples are listed in FIG. 4. The locus A target gene of samples and references were amplified with the following primers: forward primer 5′—

GGCCTCCCCAGACGCCGAGGATGGC-3′, reverse primer 5′—
CGGGTCCCGTGGCCCCTGGTACCC-3′. The amplified products were then immobilized on the substrate of the microarray. The microarray also comprised quality controls (QC) for immobilization:

5′-TTTTTTTTTTTGTCTTCCACCAGGAGTCAGCAG-3′-HEX

The microarray also had positive controls (PC) for hybridization:

5′TTTTTTTTTTAAAGTTAAAGCAGACCGAAGTGGATTGCGAGTATTTGA
AAAGATGTGTTGAGAAATTAACGGAAGAGAA-3′

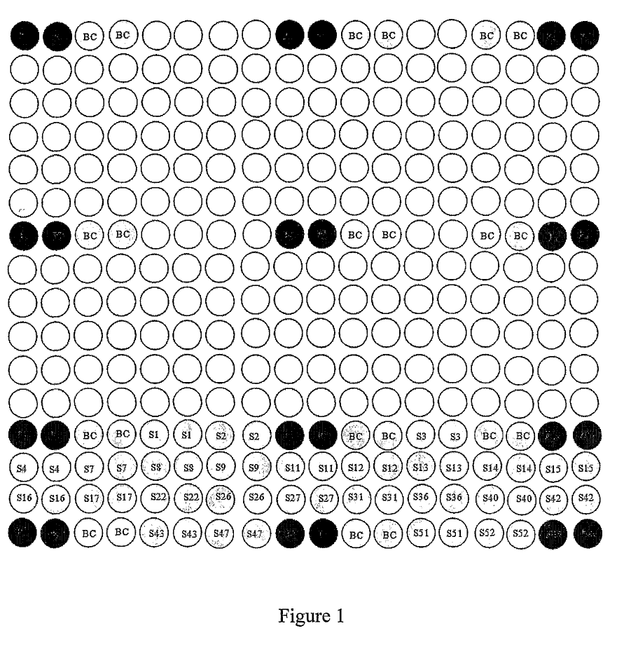

The microarray also had blank negative controls (BC), which is 50% DMSO. The HLA samples (not labeled), HLA standard samples, QC (not labeled), PC, and BC were spotted on the microarray using routine methods according to the pattern depicted in FIG. 1. An oligonucleotide probe (at the concentration of 20 nM) was allowed to hybridize to the microarray. The probe has the following sequence (A07601):

5′-CCGAGCGAACCTGGGGACC-3′

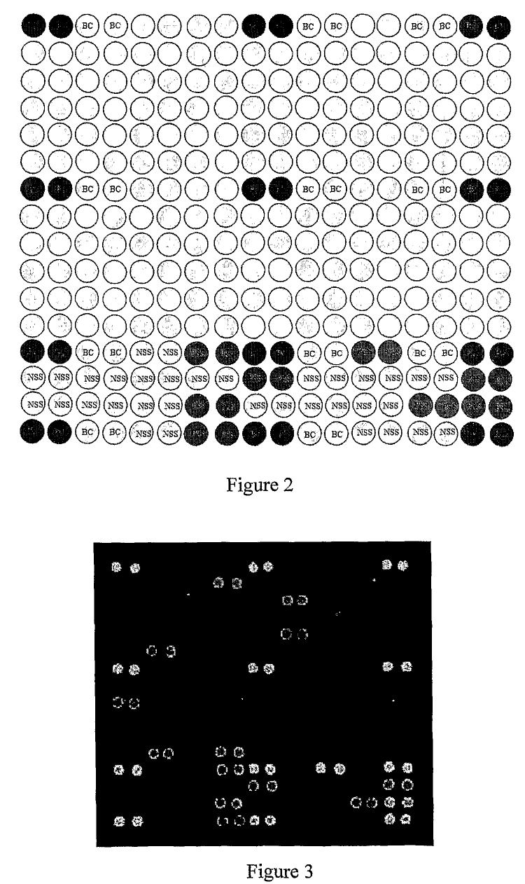

FIG. 2 shows the predicted hybridization pattern based on sequence or genotypes of the HLA standards. FIG. 3 shows the real hybridization result using the probe. As shown in FIG. 3, all the QC, PC, BC and HLA standard samples show the same hybridization pattern as the predicted hybridization pattern. In addition, there are positive spots among the unknown samples, indicating that these samples contain the same target sequence as those standard samples that show positive hybridization signals.

The method provided herein provides a simple and accurate method for detection of genotype at site of polymorphism in unknown samples.

### Example 2

This example shows preparation of a microarray used in the detection of HLA-DRB 1 using asymmetric PCR amplification method. The template used for the asymmetric PCR amplification was a HLA-DRB 1 standard genomic clone purchased from IHWG (International Histocompatibility Working Group, Seatle).

Sequences of probes and primers used the in experiments are listed below. They are synthesized by BioAsia Biotechnique Company (Shanghai, China).

HLA-DRB1primes (5′-3′) (Symmetric PCR):
Upstream primer PMH-DF
GATCCTTCGTGTCCCCACAGCAC
Downstream primer PMH-DR
CGCTGCACTGTGAAGCTCTCAC
HLA-DRB1primers (5′-3′) (Asymmetric PCR):
Upstream primer PMH_0303047a
GATCCTTCGTGTCCCCACAGCAC
Downstream primer PMH_0303048d
CGCTGCACTGTGAAGCTCTCAC
HLA-DRB1primers (5′-3′) (NP-PCR)
Upstream primer PMH-HLA-DF
CCGGATCCTTCGTGTCCCCACAGCACG
Downstream primer
PMH-HLA-DRU
TCACTTGCTTCCGTTGAGGCCGCTGCACTGTGAAGCTCT
Universal primer PMH-HLA-U1
TCACTTGCTTCCGTTGAGG
Probes (5′-3′)
Cy5-CGACAGCGACGTGGGGGA
(Universal probe)
TAMRA-AGAGGAGGCGGGCCGAGG
(Specific probe)

Reagents for the PCR reactions are the following: 2.5 mM dNTP (Shanghai BioAsia Biotechnique Company), 5 U/ul LA-Taq and 10×LA buffer (Takara, Bio Inc Dalian, China), Manu 03010 PCR product purification kit (Millipore Corporation, Mass.).

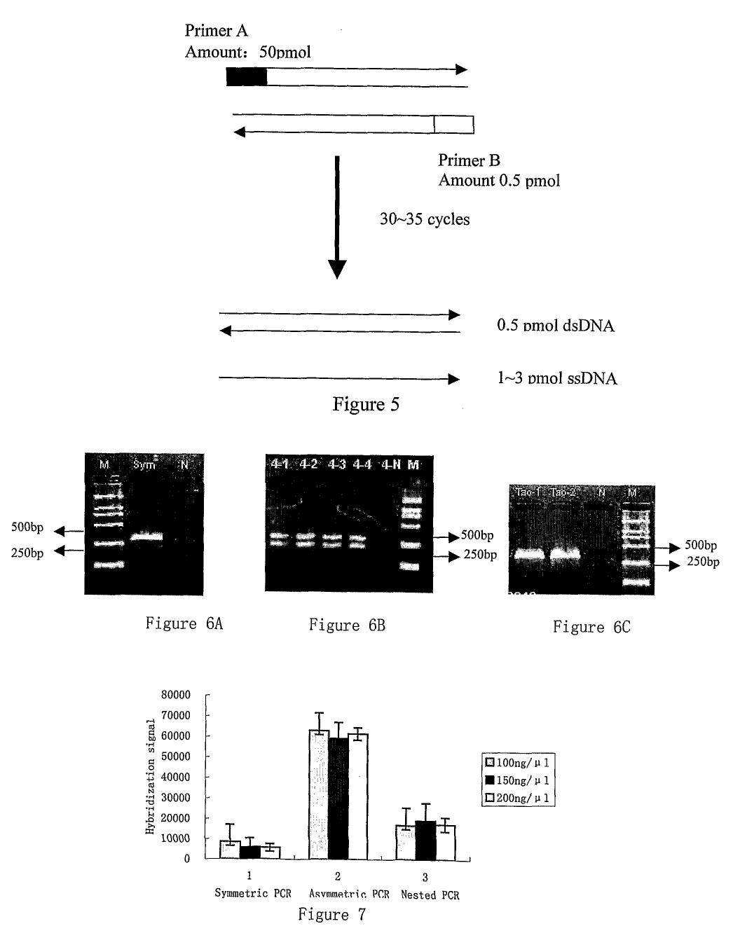

FIG. 5 shows a diagram of the asymmetric PCR amplification. In the first 20-25 PCR cycles, two primers produce double stranded DNA. Single stranded DNAs (ssDNA) are typically produced after about 25 cycles, when limited primer B had almost been used up and only one primer existed in the reaction system. This allowed ssDNA to accumulate linearly after a short rapid rise. In the present example, the primer ratio in a 100 ul asymmetric PCR reaction system was 200 pmol: 16 pmol. After 35-40 cycles, about 2-6 pmol of ssDNA was produced.

In the present experiment, HLA-DRB1 standard genome clone DNA was used as a template for standard PCR (30 cycles), nested PCR (40 cycles), and asymmetric PCR (40 cycles). At the end of the reaction, amplification products were purified by Manu 03010 PCR product purification kit. FIGS. 6A, 6B, and 6C shows agarose gel electrophoresis results of amplification products of the three PCR reactions. The results showed that asymmetric PCR could remarkably improve the yield of single stranded target molecules in the PCR products.

To make the microarray, the PCR products were dissolved in with 50% DMSO, and the products were immobilized on the surface of amino glass chip (AminoSlide™, CapitalBio Corporation, Beijing, China). The immobilization was carried out by UV ligation using UV Ligation Apparatus (Bio-Rad Laboratories, Inc.). The following probes were used to detect a sequence in the nucleic acid fragments (5′-3′):

| | |
|---|---|
| Cy5-CGACAGCGACGTGGGGGA | (universal probe) |
| TAMRA-AGaGGAGGCGGGCCGCCGAGG | (specific probe) |

The probes were labeled with corresponding fluorescent groups before hybridizing with the gene chip. After wash, hybridization signals were detected with ScanArray Express (GSI Lumonics). FIG. 7 shows the hybridization signals of various PCR products. As shown in FIG. 7, the hybridization signals of PCR products produced by asymmetric PCR amplification were significantly higher than PCR products produced by traditional PCR and nested PCR amplification methods.

We claim:

1. A microarray for detecting a genotype at a polymorphic site in a plurality of nucleic acid samples, comprising a first set of nucleic acid fragments derived from the samples and a second set of nucleic acid fragments derived from a plurality of references,
wherein the first set of nucleic acid fragments and the second set of fragments are produced by amplifying a region in the samples and references containing the polymorphism under the same conditions,
wherein both sets of nucleic acid fragments are immobilized on the surface of said microarray,
and wherein each reference comprises a known genotype at the site of the polymorphism.

2. The microarray of claim 1, wherein the references are double stranded or single stranded nucleic acids.

3. The method of claim 1, wherein at least one of the references is naturally occurring.

4. The method of claim 1, wherein at least one of the references is artificially modified.

5. The microarray of claim 1, wherein the second set of nucleic acid fragments are derived from at least 10 references.

6. The microarray of claim 1, wherein the second set of nucleic acid fragments are derived from at least 50 references.

7. The microarray of claim 1, wherein the microarray is used for determining the sequence at a polymorphic site at the HLA gene locus.

8. The microarray of claim 7, wherein each of the references is selected from the group consisting of HLA standard samples shown in FIG. 4.

9. The microarray of claim 7, wherein the references consist essentially of HLA standard samples shown in FIG. 4.

10. The microarray of claim 1, wherein at least two of the second set of nucleic acid fragments are derived from the same reference.

11. The microarray of claim 1, further comprising one or more controls selected from the group consisting of: positive controls for hybridization reactions, negative controls for hybridization reactions, and quality controls for immobilization.

12. The microarray of claim 1, wherein the first and second set of nucleic acid fragments are produced by asymmetric PCR amplification.

13. A method for detecting a genotype at a polymorphic site in a plurality of nucleic acid samples, comprising:
a) contacting a probe with the microarray of claim 1, wherein the probe detects a known genotype at the polymorphic site in at least one of the references;
b) comparing the detection signal of each sample with the detection signal of at least one of the references; and
c) determining the presence or absence of the genotype at the polymorphism in each sample based on the comparison.

14. The method of claim 13, wherein more than one probes are used.

15. The method of claim 14, wherein at least two of the probes are brought into contact with the microarray simultaneously.

16. The method of claim 14, wherein at least two of the probes are brought into contact with the microarray sequentially.

17. The method of claim 13, wherein the probe is a single nucleic acid.

18. The method of claim 13, wherein the nucleic acid fragments are produced by asymmetric PCR amplification.

19. A microarray for detecting a genotype at a polymorphic site in a plurality of nucleic acid samples, comprising a set of nucleic acid fragments immobilized on the surface of the microarray, wherein the nucleic acid fragments are derived from the samples by amplifying a region in the sample containing the polymorphism through asymmetric PCR amplification.

20. The microarray of claim 19, wherein the molar ratio of the upstream and downstream primers for the asymmetric PCR amplification is about 12.5:1 to about 100:1.

21. The microarray of claim 20, wherein the molar ratio is about 12.5:1.

22. The microarray of claim 19, wherein the number of PCR cycles of the asymmetric PCR amplification is about 30-40.

23. The microarray of claim 19, wherein the microarray is used for determining the sequence at a polymorphic site of the HLA gene locus.

24. The microarray of claim 23, wherein the sequence of upstream primer is:

| | |
|---|---|
| PMH_0303047a | GATCCTTCGTGTCCCCACAGCAC |

and the downstream primer is:

| | |
|---|---|
| PMH_0303048d | CGCTGCACTGTGAAGCTCTCAC. |

25. A method of producing a microarray for detecting a sequence at a polymorphic site in a plurality of nucleic acid samples, comprising:
a) amplifying a region in each sample containing the polymorphic site through asymmetric PCR amplification to produce a set of nucleic acid fragments ; and
b) immobilizing the nucleic acid fragments on the substrate of the microarray.

26. The method of claim 25, wherein molar ratio of the upstream and downstream primers for the asymmetric PCR amplification is about 12.5:1 to about 100:1.

27. The method of claim 26, wherein the molar ratio is about 12.5:1.

28. The method of claim 25, wherein the number of PCR cycles of the asymmetric PCR amplification is about 30-40.

29. A method for detecting a genotype at a polymorphic site in a plurality of samples, comprising:
(a) amplifying a region in each sample containing a polymorphic site through asymmetric PCR amplification to produce a set of nucleic acid fragments;
(b) immobilizing the nucleic acid fragments on the surface of the microarrays;
(c) contacting a probe with the microarray; and
(d) determining the genotypes of each sample based on signals produced by the probe.

30. The method of claim 29, wherein molar ratio of the upstream and downstream primers for the asymmetric PCR amplification is about 12.5:1 to about 100:1.

31. The method of claim 29, wherein the molar ratio is about 12.5:1.

32. The method of claim 29, wherein the number of PCR cycles of the asymmetric PCR amplification is about 30-40.
